(19) United States
(12) Patent Application Publication
(10) Pub. No.: US 2007/0173220 A1
(43) Pub. Date: Jul. 26, 2007

(54) Second-order intermodulation distortion compensating circuit

(76) Inventors: Young-Jin Kim, Yongin-si (KR); Woo-Nyun Kim, Yongin-si (KR)

Correspondence Address: F. CHAU & ASSOCIATES, LLC, 130 WOODBURY ROAD, WOODBURY, NY, 11797, US

(21) Appl. No.: 11/584,430

(22) Filed: Oct. 20, 2006

(30) Foreign Application Priority Data
Oct. 20, 2005 (KR) 2005-99094

(51) Int. Cl. H04B 1/10

(52) U.S. Cl. 455/296; 455/295

(57) ABSTRACT

A second-order intermodulation distortion (IMD2) compensating circuit that detects a variation of DC level of a voltage pair of a mixer load and adjusts the variation of the DC level of the voltage pair. The second-order intermodulation distortion compensating circuit also calibrates a mismatch of a mixer as well as a mismatch of the mixer load.

### CROSS-REFERENCE TO RELATED APPLICATION

This application claims the benefit under 35 U.S.C. § 119 of Korean Patent Application No. 2005-0099094 filed on Oct. 20, 2005, the contents of which are herein incorporated by reference in its entirety

### BACKGROUND OF THE INVENTION

1. Technical Field

The present disclosure relates to wireless telecommunications. More particularly, the present disclosure relates to wireless telecommunications using a direct conversion scheme.

2. Discussion of the Related Art

A wireless telecommunications system enables communication between a transmitter and a receiver, which are apart from each other, by transmitting a baseband signal carried on by a high-frequency carrier signal.

To retrieve a baseband signal, a superheterodyne receiver downconverts a radio frequency (RF) signal to an intermediate frequency (IF) signal and then downconverts the IF signal to the baseband signal. The superheterodyne receiver exploits the IF signal so as to use a bandpass filter with a low selectivity (Q factor). Also, the superheterodyne receiver amplifies the signals at an IF stage, as well as in an RF stage, and thus reduces a risk of oscillation that is present with a direct conversion receiver. Additionally, the superheterodyne receiver is less sensitive to a fluctuation of the RF signal due to the IF stage. Such features lead to wide uses of the superheterodyne receivers in wireless telecommunications systems.

The direct conversion receiver directly converts an RF signal to a baseband signal. The direct conversion receiver includes no IF stages, which results in a simple configuration of the system. With the direct conversion receiver, a wireless telecommunications system may be implemented by a low cost one-chip solution. In spite of these advantages, however, the direct conversion receiver still has disadvantages to be overcome, for example, mismatches between mixers cause poor performance of the direct conversion receiver.

FIG. 1 is a diagram illustrating a conventional double-balanced mixer.

The mixer includes two switch pairs 120 and 130, a mixer load 140 and a transconductance stage 110.

The transconductance stage 110 further includes transistors Q1 and Q2, which each receive an RF signal, and a current source.

Switches S1 and S2 forming the first switch pair 120, and switches S3 and S4 forming the second switch pair 130 may be implemented by metal oxide semiconductor (MOS) transistors or bipolar junction transistors. The switches S2 and S3 are controlled by a switching signal LO+ and the switches S1 and S4 are controlled by a switching signal LO−, which is 180 degree out of phase with the switching signal LO+. That is, while the switches S2 and S3 are on, the switches S1 and S4 are off, and vice versa.

The mixer load 140 includes resistors R1 and R2. The mixer is designed to have a given small-signal gain, and the mixer load 140 can adjust the small-signal gain of the mixer to eventually compensate a second order intercept point (IP2) of the mixer.

The conventional mixer requires the mixer load 140 to be well matched for improvement of the IP2 feature. It is not difficult to implement the mixer load to be well matched when the RF signal is a low frequency signal. But, with a high frequency RF signal, it is not easy to implement the mixer load to be matched well enough. Additionally, deterioration of the IP2 may be caused by mismatch of the transconductance stage, mismatch of the switch pairs, as well as mismatch of the mixer load.

### SUMMARY OF THE INVENTION

Exemplary embodiments of the present invention provide a second-order intermodulation distortion (IMD2) compensating circuit for a mixer to improve an IP2 feature of the mixer.

An exemplary embodiment of the present invention provides an IMD2 compensating circuit for a mixer to improve mismatch of a mixer load.

An exemplary embodiment of the present invention provides a direct conversion receiver including a mixer with an improved IP2 feature.

In an exemplary embodiment, a second-order intermodulation distortion (IMD2) compensating circuit includes a direct current (DC) level detecting circuit configured to generate a feedback signal based on a voltage difference between a DC level of an output terminal pair of a mixer and a reference voltage, and a calibrating circuit configured to adjust the DC level of the mixer output terminal pair to be substantially equal to the reference voltage based on the feedback signal.

The DC level detecting circuit may include a bias circuit providing the DC level detecting circuit with bias currents, a transconductance circuit receiving the bias currents to generate a feedback current corresponding to the voltage difference between the DC level of the mixer output terminal pair and the reference voltage, and a feedback signal generating circuit, which receives the feedback current to generate the feedback signal based on the feedback current.

The transconductance circuit may include first through fourth transistors, and respective sources of the first through fourth transistors may be provided with the bias currents. A gate of the first transistor and a gate of the fourth transistor may be provided with the voltage of the mixer output terminal pair, a gate of the second transistor and a gate of the third transistor may be provided with the reference voltage, and drain currents of the second and the third transistors may be added to generate the feedback current.

The feedback signal generating circuit may include a first route through which a drain current of the first transistor added to a drain current of the fourth transistor flows; a second route through which the feedback current flows and is configured to generate the feedback signal according to the feedback current; and a bias voltage generating circuit configured to provide bias voltages to the first route and the second route, respectively.

The calibrating circuit provides an output current pair based on the feedback signal.

The IMD2 compensating circuit may further include a tuning circuit configured to adjust a mismatch of the mixer. In the exemplary embodiments, the tuning circuit may generate a first calibrating current according to a calibration code, and the calibrating circuit may provide the mixer output terminal pair with an output current pair based on the feedback signal and the first calibrating current.

The IMD2 compensating circuit may further include a code generator for generating a calibration code according to a mismatch of the mixer. In the exemplary embodiments, the code generator may generate the calibration code based on a voltage difference between the mixer output terminal pairs.

In an exemplary embodiment, a direct conversion receiver includes a low noise amplifier amplifying a received radio frequency (RF) signal; a mixer directly converting the amplified RF signal to a baseband signal; a direct current (DC) level detecting circuit configured to detect a voltage difference between a DC level of an output terminal pair of the mixer and a reference voltage to generate a feedback signal; and a calibrating circuit configured to adjust the DC level of the mixer output terminal pair to be substantially equal to the reference voltage based on the feedback signal.

The DC level detecting circuit may include a bias circuit providing the DC level detecting circuit with bias currents; a transconductance circuit receiving the bias currents to generate a feedback current corresponding to the voltage difference between the DC level of the mixer output terminal pair and the reference voltage; and a feedback signal generating circuit receiving the feedback current to generate the feedback signal based on the feedback current.

The transconductance circuit may include first through fourth transistors. Respective sources of the first through fourth transistors may be provided with the bias currents. A gate of the first transistor and a gate of the fourth transistor may be provided with the voltage of the mixer output terminal pair. A gate of the second transistor and a gate of the third transistor may be provided with the reference voltage, and drain currents of the second and the third transistors may be added to generate the feedback current.

The feedback signal generating circuit may include a first route through which a drain current of the first transistor added to a drain current of the fourth transistor flows; a second route through which the feedback current flows, and configured to generate the feedback signal according to the feedback current; and a bias voltage generating circuit configured to provide bias voltages to the first route and the second route, respectively.

The calibrating circuit may provide an output current pair based on the feedback signal.

The direct conversion receiver may further include a tuning circuit configured to adjust a mismatch of the mixer. The tuning circuit may generate a calibrating current according to a calibration code, and the calibrating circuit may provide the mixer output terminal pair with an output current pair based on the feedback signal and the calibrating current.

The direct conversion receiver may further include a code generator for generating a calibration code according to a mismatch of the mixer.

### BRIEF DESCRIPTION OF THE DRAWINGS

Exemplary embodiments of the present invention will be understood in more detail from the following descriptions taken in conjunction with the accompanying drawings, in which:

FIG. 1 is a circuit diagram illustrating a conventional mixer circuit;

FIG. 2 is a block diagram illustrating a direct conversion receiver according to an exemplary embodiment of the present invention;

FIG. 3 illustrates a second-order intermodulation distortion (IMD2) compensating circuit and a mixer according to an exemplary embodiment of the present invention;

FIG. 4 illustrates an IMD2 compensating circuit and a mixer according to an exemplary embodiment of the present invention;

FIG. 5 is a block diagram illustrating an IMD2 compensating circuit according to an exemplary embodiment of the present invention;

FIG. 6 is a detailed block diagram illustrating an IMD2 compensating circuit according to an exemplary embodiment of the present invention;

FIG. 7 is a detailed block diagram illustrating an IMD2 compensating circuit according to an exemplary embodiment of the present invention;

FIG. 8 is a detailed block diagram illustrating an IMD2 compensating circuit according to an exemplary embodiment of the present invention;

FIG. 9 is a detailed block diagram illustrating an IMD2 compensating circuit according to an exemplary embodiment of the present invention;

FIG. 10 is a graph showing variation of IP2 value for different calibration codes according to an exemplary embodiment of the present invention;

FIG. 11 is a graph showing variation of calibration current for different calibration codes according to an exemplary embodiment of the present invention;

FIG. 12 is a graph showing variation of IP2 value in an implemented circuit according to an exemplary embodiment of the present invention.

### DESCRIPTION OF EXEMPLARY EMBODIMENTS

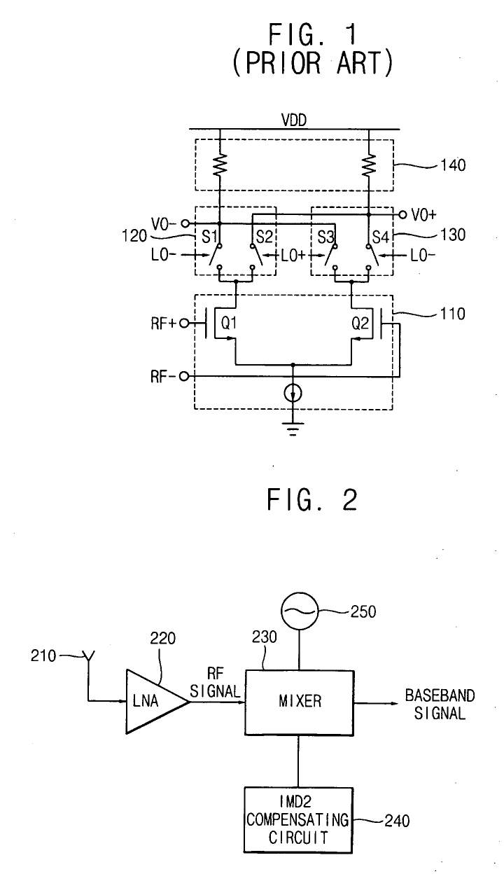

FIG. 2 is a block diagram illustrating a direct conversion receiver according to an exemplary embodiment of the present invention.

A direct conversion receiver includes a receiving circuit 210 for receiving a radiofrequency (RF) signal, a low noise amplifier (LNA) 220 for amplifying the received RF signal, a mixer 230, a second-order intermodulation distortion (IMD2) compensating circuit 240 for calibrating output signals from the mixer 230, and a local oscillator 250.

The receiving circuit 210 receives an RF signal among RF signals transmitted through a media. To do this, the receiving circuit 210 may include an antenna, a band pass filter, and so on.

The LNA 220 amplifies the received RF signal enough to be processed at the following stage, and the amplified RF signal is provided to the mixer 230.

The mixer 230 performs down-conversion with respect to the amplified RF signal directly to the base band. For the performance of the mixer 230, the local oscillator 250 generates a signal having the same frequency as that of the RF signal and provides the generated signal to the mixer 230.

Typically, mixer output signals in the direct conversion operation comprise a pair of differential signals. The mixer output signals usually contain a direct current (DC) offset due to the IMD2. The IMD2 compensating circuit may lessen the IMD2.

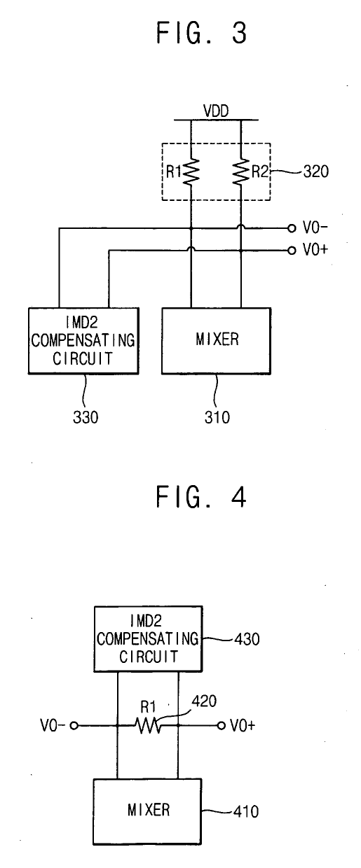

The IMD2 compensating circuit 240 reduces IMD2 in the output signal of the mixer 230 and reduces mismatches in the mixer 230 such as a mismatch of mixer loads. The IMD2 compensating circuit 240 and the mixer 230 may be connected as shown in FIGS. 3 and 4.

Referring to FIG. 3, the mixer 310 is connected to a mixer load 320 formed with resistors R1 and R2 at an output terminal pair, and outputs an output signal pair VO+ and VO− in base band via the output terminal pair. The resistors R1 and R2 in the mixer load 320 have the same resistance value.

The IMD2 compensation circuit 330 is provided with DC voltage levels of the output terminal pair of the mixer 310 and maintains the levels of the output signal pair VO+ and VO− by a negative feedback configuration.

A current flowing into the mixer is substantially equal to a sum of a current flowing through the mixer load 320 and a current provided from the IMD2 compensating circuit 330. The mixer 310 contains a current source (not shown) for a current to flow. Referring to FIG. 1, the transconductance stage 110 contains a current source, and the current flowing through the mixer load 140 has the same level as that of the current generated by the current source of the transconductance stage 110. In exemplary embodiments of the present invention, a current flowing through the mixer 310 maintains a constant value. Thus, when a current provided from the IMD2 compensating circuit 330 increases, a current flowing through the mixer load 320 decreases and the DC levels of the output signal pair VO+ and VO− are lowered. In other words, if the DC levels of the output signal pair VO+ and VO− are increased, the IMD2 compensating circuit 330 provides more current. On the contrary, if the DC levels of the output signal pair VO+ and VO− are lowered, the IMD2 compensating circuit 330 provides less current.

Concerning a mismatch in the mixer load 320 or a mismatch in the mixer 310, the IMD2 compensating circuit 330 provides a current corresponding to the mismatches so as to mitigate influence by the mismatches. It is very difficult, however, to implement the resistors R1 and R2 in the mixer load 320 to be identical to each other. The IMD2 compensating circuit 330 according to exemplary embodiments of the invention may have a reduced influence by the mismatches of the mixer load 320 or the mixer 310, which is described as follows.

Referring to FIG. 4, a mixer 410 is connected to a mixer load 420 formed by a resistor R1 at an output terminal pair and outputs an output signal pair VO+ and VO− in base band via the output terminal pair. A current supplied from an IMD2 compensating circuit 430 flows through the mixer 410. The IMD2 compensating circuit 430 maintains the levels of the output signal pair VO+ and VO− outputted from the output terminal pair of the mixer 410. Additionally, the IMD2 compensating circuit 430 provides a voltage to the terminals of the mixer load 420 according to the mismatch of the mixer 420.

The IMD2 compensating circuit to compensate the mismatch in the mixer load including two resistors as in FIG. 3 will be described in detail as follows.

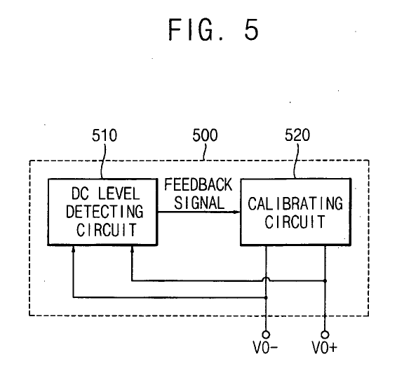

FIG. 5 is a block diagram illustrating an IMD2 compensating circuit according to an exemplary embodiment of the present invention.

An IMD2 compensating circuit 500 includes a DC level detecting circuit 510 for detecting DC levels of an output signal pair VO+ and VO− at an output terminal pair of a mixer and a calibrating circuit 520 for compensating the DC levels of the output signal pair VO+ and VO−.

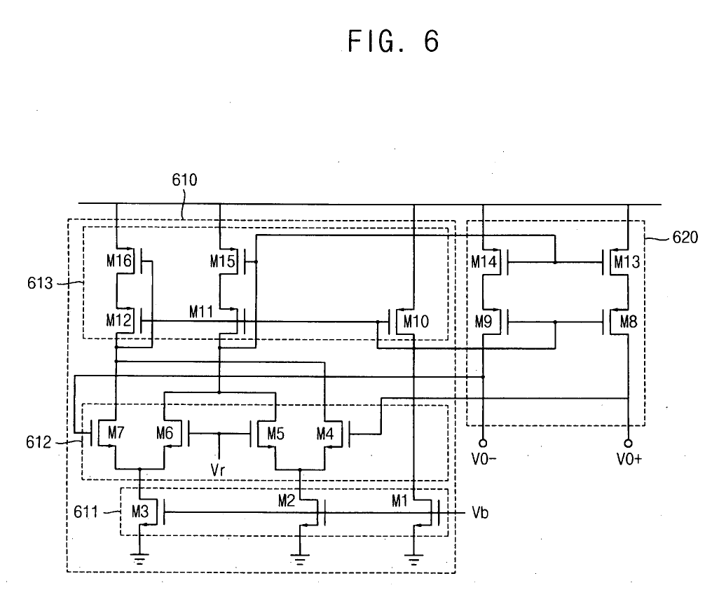

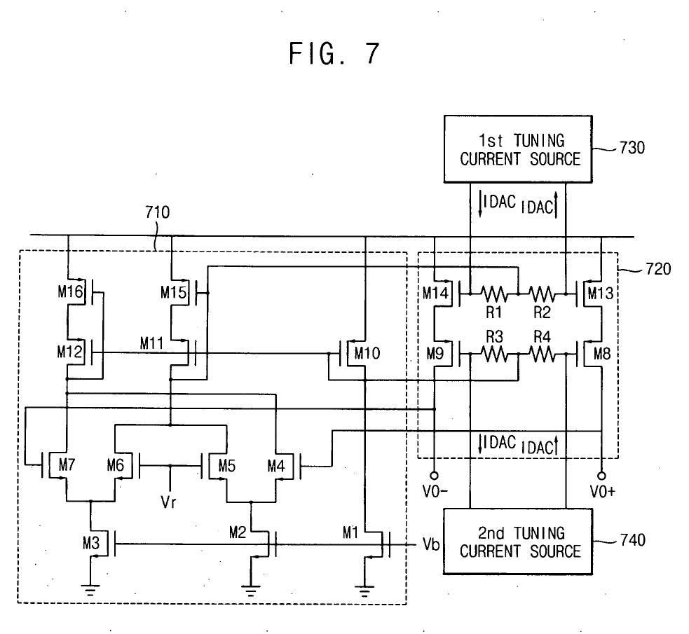

The DC level detecting circuit 510 measures voltage differences between a reference voltage (not shown) and the output signal pair VO+ and VO− of the output terminal pair of the mixer so as to generate a feedback signal based on the voltage difference between the reference voltage and the output signal pair VO+ and VO−. The feedback signal is provided to the calibrating circuit 520. The calibrating circuit 520 adjusts the DC levels of the mixer output terminal pair to be substantially equal to the reference voltage based on the feedback signal. The calibrating circuit may be implemented as various circuits shown in FIGS. 6 through 9, or as another circuit not shown in FIGS. 6 through 9.

FIG. 6 is a detailed block diagram illustrating an IMD2 compensating circuit according to an exemplary embodiment of the present invention.

An IMD2 compensating circuit includes a DC level detecting circuit 610 and a calibrating circuit 620.

The DC level detecting circuit 610 further includes a bias circuit 611, a transconductance circuit 612 and a feedback signal generating circuit 613.

The bias circuit 611 includes transistors M1, M2 and M3 to provide bias currents according to a bias voltage Vb.

The transconductance circuit 612 is provided with bias currents from the bias circuit 611 and receives the output signal pair VO+ and VO− from the output terminal pair of the mixer. The transconductance circuit 612 is implemented with four transistors M4, M5, M6 and M7 and compares the output signal pair VO+ and VO− with a reference voltage Vr.

The transistors M4 and M5 are provided with the bias current from the transistor M2 to compare one output signal VO+ with the reference voltage Vr. More specifically, the output signal VO+ is applied to a gate of the transistor M4 and the reference voltage Vr is applied to a gate of the transistor M5. In case that a voltage level of the output signal VO+ is larger than that of the reference voltage Vr, a drain current of the transistor M4 becomes larger than a drain current of the transistor M5.

In case that the voltage level of the output signal VO+ is smaller than that of the reference voltage Vr, the drain current of the transistor M4 becomes smaller than the drain current of the transistor M5.

The transistors M6 and M7 are provided with the bias current from the transistor M3 to compare the other output signal VO− with the reference voltage Vr. In detail, the output signal VO− is applied to a gate of the transistor M7 and the reference voltage Vr is applied to a gate of the transistor M6. When a voltage level of the other output signal VO− is larger than that of the reference voltage Vr, a drain current of the transistor M7 becomes larger than a drain current of the transistor M6. When the voltage level of the output signal VO− is, smaller than that of the reference voltage Vr, the drain current of the transistor M7 becomes smaller than the drain current of the transistor M6.

To summarize, a DC level of the output signal pair VO+ and VO− is increased when a drain current of a transistor M11 decreases, and the DC level of the output signal pair VO+ and VO− drops when a drain current of a transistor M11 increases.

The feedback signal generating circuit 613 includes two routes. When the DC level of the output signal pair VO+ and VO− is increased, a current flowing through a first route is increased and a current flowing through a second route is decreased. On the contrary, when the DC level of the output signal pair VO+ and VO− drops, the current flowing through the first route is decreased and the current flowing through the second route is increased.

The first route includes transistors M12 and M16. A drain of the transistor M12 releases a summed current of the drain current of the transistor M4 and the drain current of the transistor M7. The second route includes transistors M11 and M15. A drain of the transistor M11 releases a summed current of the drain current of the transistor M5 and the drain current of the transistor M6.

Gates of the transistors M11 and M12 are connected to a gate of a transistor M10. The transistor M10 is provided with the bias current from the transistor M1 to provide a bias voltage to the gates of the transistors M11 and M12.

The transistor M15 has a source connected to the drain of the transistor M11, and a gate connected to the drain of the transistor M11. A voltage level of the gate of the transistor M15 decreases as the drain current of the transistor M15 increases while the voltage level of the gate of the transistor M15 increases as the drain current of the transistor M15 decreases. The gate voltage of the transistor M15 serves as the feedback signal for the output signal pair VO+ and VO− to be provided to the calibrating circuit 620.

The calibrating circuit 620 adjusts the DC levels of the mixer output terminal pair to be substantially equal to the reference voltage based on the feedback signal. To do this, the calibrating circuit 620 receives the feedback signal and provides an output current pair to the mixer. When a voltage level of the feedback signal is increased, the amplitude of the output current pair is decreased and the DC level of the mixer output terminal pair is lowered. On the contrary, when a voltage level of the feedback signal drops, both the amplitude of the output current pair and the DC level of the mixer output terminal pair are increased.

The calibrating circuit 620 includes transistors M13 and M14 for receiving the feedback signal at respective gates and transistors M8 and M9 for receiving the bias voltage from the transistor M10 at respective gates. A current of the transistors M9 and M14 and a current of the transistors M11 and M15 respectively release mirrored currents of the drain currents of the transistors M11 and M15.

If the DC level of the mixer output terminal pair or average value of the output signal pair VO+ and VO− is increased, the current flowing through the transistors M11 and M15 is decreased, and then the current flowing through transistors M9 and M14, as well as the current flowing through transistors M8 and M13, is decreased. The DC level of the mixer output terminal pair then drops as the current flowing through transistors M9 and M14 and the current flowing through transistors M8 and M13 are decreased.

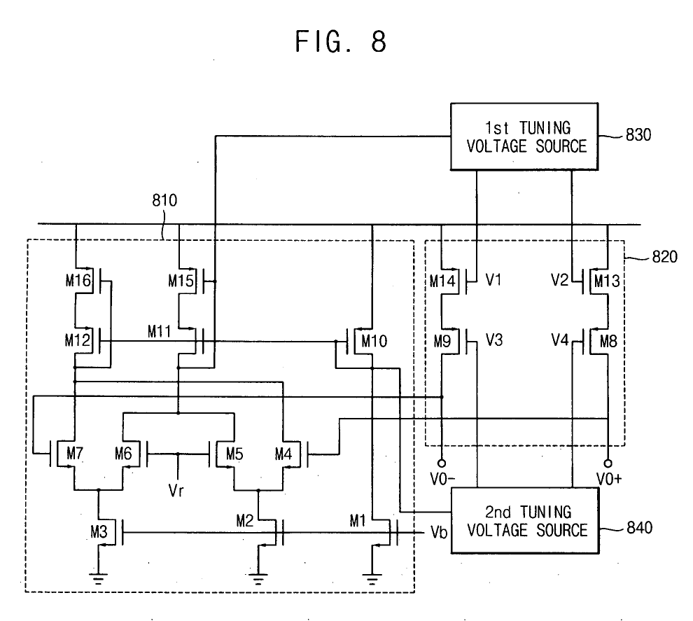

The second-order intermodulation distortion caused by the mismatches in the mixer and/or the mixer load may be decreased by forcing the current of the transistors M9 and M14 to have a different value from the current of the transistors M8 and M13. This will be described in FIGS. 7 and 8.

FIG. 7 is a detailed block diagram illustrating an IMD2 compensating circuit according to an exemplary embodiment of the present invention.

The IMD2 compensating circuit includes a DC level detecting circuit 710 and a calibrating circuit 720. The DC level detecting circuit 710 compares the output signal pair VO+ and VO− with the reference voltage Vr to generate a feedback signal. The DC level detecting circuit 710 may have substantially the same functions as the DC level detecting circuit 610 in FIG. 6. Elements for implementing the DC level detecting circuit 710 may be identical to those of the DC level detecting circuit 610 in FIG. 6. Therefore, the description for the DC level detecting circuit 710 may be omitted.

The IMD2 compensating circuit may further include a tuning circuit for reducing IMD2 caused by the mismatches in the mixer and/or the mixer load. For example, a first tuning current source 730 and a second tuning current source 740 respectively provide calibrating currents IDAC for reducing the IMD2 caused by mismatches in the mixer and/or the mixer load.

The calibrating circuit 720 generates an output current pair based on the feedback signal from the DC level detecting circuit 710 and the calibrating current IDAC. For example, a third route, which connects between the gate of the transistor M13 and the gate of the transistor M14, includes resistors R1 and R2. A node between the resistors R1 and R2 is provided with the feedback signal. The calibrating current IDAC provided from one terminal of the first tuning current source 730 flows through the third route to the other terminal of the first tuning current source 730. Therefore, the gate voltage of the transistor M13 becomes different from the gate voltage of the transistor. M14. For example, in case that the gate voltage of the transistor M13 is greater than that of the transistor M14, the drain current of the transistor M13 becomes smaller than that of the transistor M14. On the contrary, in case that the gate voltage of the transistor M13 is smaller than that of the transistor M14, the drain current of the transistor M13 becomes larger than that of the transistor M14. The amplitude of the calibrating current IDAC may be adjusted by a calibration code. The resistors R1 and R2 may be equal to each other or different from each other. Furthermore, the third route may include only one of the resistors R1 and R2.

The second tuning current source 740 is capable of changing the gate voltages of the transistors M8 and M9. A fourth route between the gates of the transistors M8 and M9 includes resistors R3 and R4. A node between the resistors R3 and R4 is provided with the bias voltage from the transistor M10. The calibrating current IDAC provided from one terminal of the second tuning current source 740 flows through the fourth route to the other terminal of the second tuning current source 740. When the calibrating current IDAC is larger than 0, the drain current of the transistor M13 becomes larger than that of the transistor M14. That is, a source-gate voltage of the transistor M13 becomes larger than that of the transistor M14 and a source-gate voltage of the transistor M8 becomes greater than that of transistor M9. In this case, the calibrating current IDAC from the second tuning current source 740 is determined for the gate voltage of the transistor M8 to be greater than that of the transistor M9. Therefore, possible imbalance of the voltages of the mixer output terminal pair by the calibration circuit 720 may be amended by the tuning current sources 730 and 740. Inequality between the output current pair caused by the calibration currents IDAC may amend the IMD2 by the mismatches of the mixer and/or the mixer load. The resistors R3 and R4 may be equal to each other or different from each other. Furthermore, the fourth route may include only one resistor of the resistors R3 and R4.

FIG. 8 is a detailed block diagram illustrating an IMD2 compensating circuit according to an exemplary embodiment of the present invention.

While the IMD2 compensating circuit in FIG. 7 uses the calibrating currents to reduce the IMD2 caused by the mixer and/or the mixer load, an IMD2 compensating circuit in FIG. 8 directly applies different gate voltages to gates of respective transistors included in a calibrating circuit 820.

The IMD2 compensating circuit includes a DC level detecting circuit 810 and the calibrating circuit 820. The DC level detecting circuit 810 compares the output signal pair VO+ and VO− with the reference voltage Vr to generate a feedback signal. The DC level detecting circuit 810 may have substantially the same functions as the DC level detecting circuit 610 in FIG. 6. Elements for implementing the DC level detecting circuit 810 may be identical to those of the DC level detecting circuit 610 in FIG. 6. Therefore, the description for the DC level detecting circuit 810 may be omitted.

The IMD2 compensating circuit may further include tuning circuits for reducing IMD2 caused by the mismatches in the mixer and/or the mixer load. For example, a first tuning voltage source 830 and a second tuning voltage source 840 provide feedback voltages V1, V2, V3 and V4 for reducing the IMD2 caused by the mismatches in the mixer and/or the mixer load.

The first tuning voltage source 830 receives the feedback signal from the, DC level detecting circuit 810 and generates the first feedback voltage V1 and the second feedback voltage V2 based on the feedback signal and a calibration code. The first feedback voltage V1 is provided to a gate of a transistor M14 and the second feedback voltage V2 is provided to a gate of a transistor M13. In the case that the feedback voltage V1 is higher than the feedback voltage V2, a drain current of the transistor M13 becomes larger than that of the transistor M14. It is similar to the case of the IMD2 compensating circuit shown in FIG. 7 in which the drain currents of the transistors M13 and M14 flow differently by the calibrating currents IDAC.

Similarly, the second tuning voltage source 840 receives the feedback signal and generates the third feedback voltage V3 and the fourth feedback voltage V4 based on the feedback signal and the calibration code. The third feedback voltage V3 is provided to the gate of the transistor M9 and the fourth feedback voltage V4 is provided to the gate of the transistor M8. In such a manner, the second tuning voltage source 840 prevents the mixer output terminal pair from having a voltage imbalance.

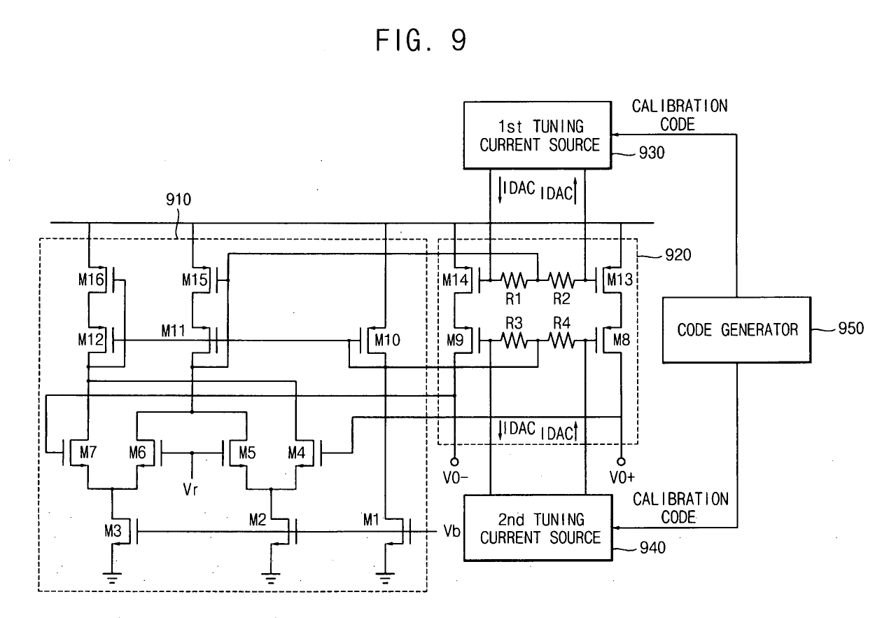

FIG. 9 is a detailed block diagram illustrating an IMD2 compensating circuit according to an exemplary embodiment of the present invention.

The IMD2 compensating circuit includes a DC level detecting circuit 910 and a calibrating circuit 920. The DC level detecting circuit 910 compares the output signal pair VO+ and VO− with the reference voltage Vr to generate a feedback signal. The DC level detecting circuit 910 may have substantially the same functions as the DC level detecting circuit 610 shown in FIG. 6. Elements for implementing the DC level detecting circuit 910 may be identical to those of the DC level detecting circuit 610 in FIG. 6. Therefore, the description for the DC level detecting circuit 910 may be omitted.

The IMD2 compensating circuit may further include tuning circuits for reducing IMD2 caused by the mismatches in the mixer and/or the mixer load that are to the IMD2 compensating circuit in FIG. 7.

For example, a first tuning current source 930 and a second tuning current source 940 respectively provide calibrating currents IDAC for reducing the IMD2 caused by mismatches in the mixer and/or the mixer load. Operations of the first and the second tuning current sources 930 and 940 as well as an operation of the calibrating circuit 920 are substantially the same as those of the IMD2 compensating circuit shown in FIG. 7, hence corresponding descriptions are omitted accordingly.

The IMD2 compensating circuit may further include a code generator 950 for providing the calibration code to the tuning circuits, that is, the first tuning current source 930 and the second tuning current source 940. The code generator 950 probes the output signal pair VO+ and VO− of the mixer output terminal pair, although the connections are not shown, and generates the calibration code so as to reduce the mismatches in the mixer and/or the mixer load. Once the voltage level of the output signal pair VO+ and VO− is adjusted by the first tuning current source 930, the second tuning current source 940 and the calibrating circuit 920 (not shown) according to a calibration code, then the code generator 950 generates a new calibration code based on the adjusted voltage level of the output signal pair VO+ and VO−. That is, the IMD2 compensating circuit repeats probing and calibrating the voltage level of the output signal pair VO+ and VO−, and the code generator 950 generates different calibration codes until an optimized calibration code is generated. The first and the second tuning current sources 930 and 940 generate the calibrating currents IDAC according to the optimized calibration code.

Although illustrated as not including the code generator, the IMD2 compensating circuit in FIG. 8 may also include the code generator as shown in FIG. 9.

Although so far illustrated as including two tuning circuits with two terminals each, the IMD2 compensating circuits may be implemented as including one tuning circuit with four terminals.

Variation of the IP2 value according to the calibration circuit will now be described.

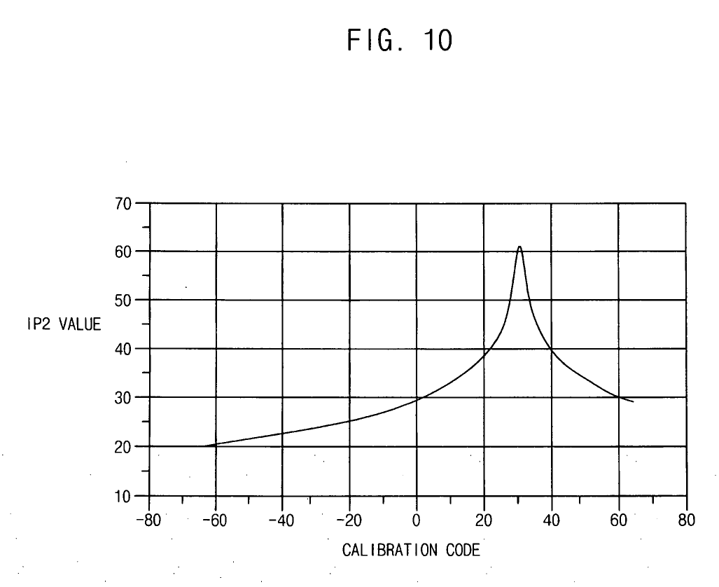

FIG. 10 is a graph showing a variation of the IP2 value for different calibration codes according to an exemplary embodiment of the present invention. The horizontal axis corresponds to the calibration code and the vertical axis corresponds to the IP2 value.

In exemplary embodiments of the present invention, the calibration code may have eight bits of code data and one bit of sign. In an implementation of the mixer and the IMD2 compensating circuit as shown in FIG. 7, the IP2 characteristics are at their fullest when the calibration code is 26 or 27, as shown in FIG. 10. The optimized calibration code may vary according to the mismatches in the mixer and/or the mixer load when actually implemented.

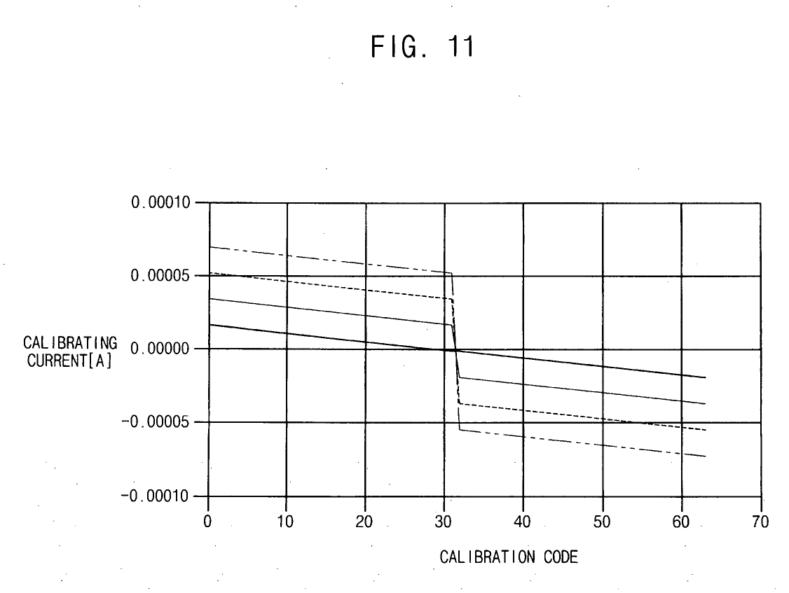

FIG. 11 is a graph showing variation of calibration current for different calibration codes according to exemplary embodiments of the present invention. The horizontal axis corresponds to the calibration code and the vertical axis corresponds to the amplitude of the calibrating current.

In case that that amplitude of the calibrating current varies only a little, according to a variation of the calibration code, a range of the mismatches to be compensated is also reduced. Therefore, in the exemplary embodiments, two bits from the calibration code are assigned for a coarse tuning to broaden the range of the mismatches to be compensated, and eight bits from the calibration code are assigned for a fine tuning.

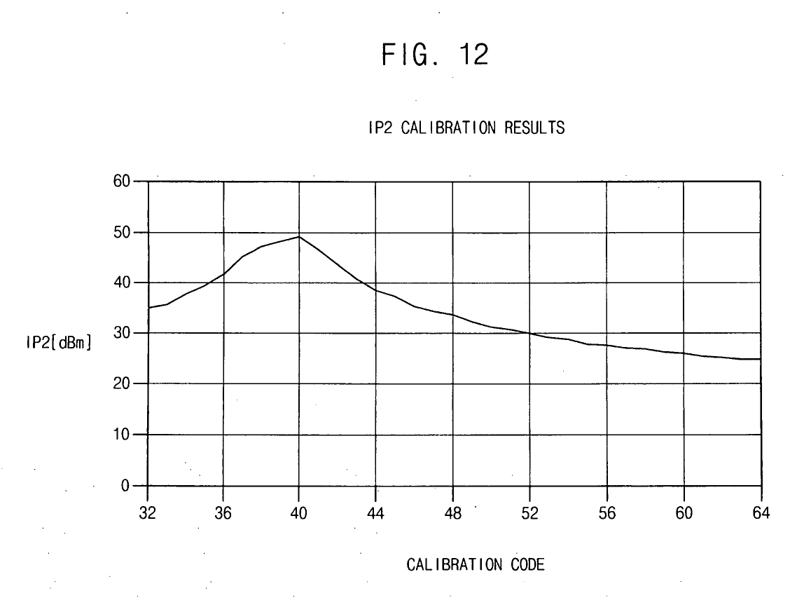

FIG. 12 is a graph showing variations of the IP2 value in an implemented mixer using 10-bit calibration code, according to an exemplary embodiment of the present invention. Here, the IP2 characteristic is at its fullest when the calibration code is 40. The optimized calibration code may be different according to the mismatches of the mixer.

The IMD2 compensating circuits according to exemplary embodiments of the present invention reduce influence of the IMD2 by adjusting the DC level of the mixer output terminal pair to a desired value. The IMD2 compensating circuits according to an exemplary embodiment of the present invention compensate the mismatches of the mixer and/or the mixer load using a calibration code.

The direct conversion receiver according to an exemplary embodiment of the present invention includes a mixer with an improved IP2 characteristics and a low signal distortion by second-order intermodulation.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed exemplary embodiments, as well as other embodiments, are intended to be included within the scope of the appended claims. The invention is defined by the following claims, with equivalents of the claims to be included therein.

What is claimed is:

1. A second-order intermodulation distortion (IMD2) compensating circuit comprising:
a direct current (DC) level detecting circuit configured to generate a feedback signal based on a voltage difference between a DC level of an output terminal pair of a mixer and a reference voltage; and
a calibrating circuit configured to adjust the DC level of the mixer output terminal pair to be substantially equal to the reference voltage based on the feedback signal.

2. The IMD2 compensating circuit of claim 1, wherein the DC level detecting circuit comprises:
a bias circuit providing the DC level detecting circuit with bias currents;
a transconductance circuit receiving the bias currents to generate a feedback current corresponding to the voltage difference between the DC level of the mixer output terminal pair and the reference voltage; and
a feedback signal generating circuit receiving the feedback current to generate the feedback signal based on the feedback current.

3. The IMD2 compensating circuit of claim 2, wherein the transconductance circuit comprises first through fourth transistors, and wherein respective sources of the first through fourth transistors are provided with the bias currents, a gate of the first transistor and a gate of the fourth transistor are provided with the voltage of the mixer output terminal pair, a gate of the second transistor and a gate of the third transistor are provided with the reference voltage, and drain currents of the second and the third transistors are added to generate the feedback current.

4. The IMD2 compensating circuit of claim 2, wherein the feedback signal generating circuit comprises:
a first route through which a drain current of the first transistor added to a drain current of the fourth transistor flows;
a second route through which the feedback current flows and configured to generate the feedback signal according to the feedback current; and
a bias voltage generating circuit configured to provide bias voltages to the first route and the second route respectively.

5. The IMD2 compensating circuit of claim 4, wherein the first route comprises:
a fifth transistor in which a gate is provided with the bias voltage and a drain is connected with drains of the first and the fourth transistors; and
a sixth transistor in which a gate and a drain are respectively connected with a drain and a source of the fifth transistor, and wherein the second route comprises:
a seventh transistor in which a gate is provided with the bias voltage and a drain is connected with drains of the second and the third transistors; and
an eighth transistor in which a gate and a drain are respectively connected with a drain and a source of the seventh transistor, wherein the gate provides the feedback signal.

6. The IMD2 compensating circuit of claim 2, wherein the calibrating circuit provides an output current pair based on the feedback signal.

7. The IMD2 compensating circuit of claim 1, further comprising a first tuning circuit configured to adjust a mismatch of the mixer.

8. The IMD2 compensating circuit of claim 7, wherein the first tuning circuit generates a first calibrating current according to a calibration code, and the calibrating circuit provides the mixer output terminal pair with an output current pair based on the feedback signal and the first calibrating current.

9. The IMD2 compensating circuit of claim 8, wherein the calibrating circuit comprises:
a ninth transistor, a tenth transistor in which a source is connected to a drain of the ninth transistor, an eleventh transistor, and a twelfth transistor in which a source is connected to a drain of the eleventh transistor;
a gate of the ninth transistor being connected to one terminal of the first tuning circuit and a gate of the eleventh transistor being connected to the other terminal of the first tuning circuit;
the first calibrating current flowing through a third route connecting the gate of the ninth transistor and the gate of the eleventh transistor;
the third route being provided with the feedback signal to supply different voltages to the gates of the ninth and the eleventh transistors; and
the output current pair being released at drains of the tenth and the twelfth transistors to the mixer output terminal pair.

10. The IMD2 compensating circuit of claim 9, further comprising a second tuning circuit configured to generate a second calibrating current corresponding to the calibration code, wherein the second calibrating current flows through a fourth route connecting a gate of the tenth transistor and a gate of the twelfth transistor, and the fourth route is provided with the bias voltage.

11. The IMD2 compensating circuit of claim 1, further comprising a third tuning circuit configured to compensate a mismatch of the mixer, wherein the calibrating circuit comprises a ninth transistor, a tenth transistor in which a source is connected to a drain of the ninth transistor, an eleventh transistor, and a twelfth transistor in which a source is connected to a drain of the eleventh transistor;
the third tuning circuit generating a first feedback voltage and a second feedback voltage based on the feedback signal and a calibration code providing the first feedback voltage to a gate of the ninth transistor and providing the second feedback voltage to the drain of the eleventh transistor; and
the output current pair from the ninth and the eleventh transistors being provided through the drains of the tenth and the twelfth transistors to the mixer output terminal pair.

12. The IMD2 compensating circuit of claim 11, further comprising a fourth tuning circuit wherein the fourth tuning circuit generates a third feedback voltage and a fourth feedback voltage based on a bias voltage and the calibration code, provides the third feedback voltage to a gate of the tenth transistor, and provides the fourth feedback voltage to the drain of the twelfth transistor.

13. The IMD2 compensating circuit of claim 1, further comprising:
a code generator for generating a calibration code according to a mismatch of the mixer; and
a tuning circuit for calibrating the mismatch of the mixer based on the calibration code.

14. The IMD2 compensating circuit of claim 13, wherein the tuning circuit generates a calibrating current, the calibrating circuit provides an output current pair to the mixer output terminal based on the feedback signal and the calibrating current, and the code generator generates the calibration code based on voltage difference between the mixer output terminal pair.

15. The IMD2 compensating circuit of claim 14, wherein the calibrating circuit comprises a ninth transistor, a tenth transistor in which a source is connected to a drain of the ninth transistor, an eleventh transistor, and a twelfth transistor in which a source is connected to a drain of the eleventh transistor;
a gate of the ninth transistor being connected to one terminal of the first tuning circuit and a gate of the eleventh transistor being connected to the other terminal of the first tuning circuit;
the first calibrating current flowing through a third route which connects the gate of the ninth transistor and the gate of the eleventh transistor, the third route being provided with the feedback signal to supply different voltages to the gates of the ninth and the eleventh transistors; and
the output current pair being released at drains of the tenth and the twelfth transistors to the mixer output terminal pair.

16. The IMD2 compensating circuit of claim 15, wherein the tuning circuit further comprises a third terminal and a fourth terminal releasing a second-calibrating current corresponding to the calibration code, the second calibrating current flowing through a fourth route which connects the gate of the tenth transistor and a gate of the twelfth transistor, wherein a bias voltage is provided into the fourth route.

17. The IMD2 compensating circuit of claim 13, wherein the calibrating circuit comprises a ninth transistor, a tenth transistor in which a source is connected to a drain of the ninth transistor, an eleventh transistor, and a twelfth transistor in which a source is connected to a drain of the eleventh transistor;
the third tuning circuit generating a first feedback voltage and a second feedback voltage based on the feedback signal and a calibration code, providing the first feedback voltage to a gate of the ninth transistor, and providing the second feedback voltage to the drain of the eleventh transistor; and
the output current pair from the ninth and the eleventh transistors being provided through the drains of the tenth and the twelfth transistors to the mixer output terminal pair.

18. The IMD2 compensating circuit of claim 17, wherein the tuning circuit generates a third feedback voltage and a fourth feedback voltage based on a bias voltage and the calibration code, provides the third feedback voltage to a gate of the tenth transistor, and provides the fourth feedback voltage to the drain of the twelfth transistor.

19. A direct conversion receiver comprising:
a low noise amplifier amplifying a received radio frequency (RF) signal;
a mixer directly converting the amplified RF signal to a baseband signal;
a direct current (DC) level detecting circuit configured to detect a voltage difference between a DC level of an output terminal pair of the mixer and a reference voltage to generate a feedback signal; and
a calibrating circuit configured to adjust the DC level of the mixer output terminal pair to be substantially equal to the reference voltage based on the feedback signal.

20. The direct conversion receiver of claim 19, wherein the DC level detecting circuit comprises:
a bias circuit providing the DC level detecting circuit with bias currents;
a transconductance circuit receiving the bias currents to generate a feedback current corresponding to the voltage difference between the DC level of the mixer output terminal pair and the reference voltage; and
a feedback signal generating circuit receiving the feedback current to generate the feedback signal based on the feedback current.

21. The direct conversion receiver of claim 20, wherein the transconductance circuit comprises first through fourth transistors, and wherein respective sources of the first through fourth transistors are provided with the bias currents, a gate of the first transistor and a gate of the fourth transistor are provided with the voltage of the mixer output terminal pair, a gate of the second transistor and a gate of the third transistor are provided with the reference voltage, and drain currents of the second and the third transistors are added to generate the feedback current.

22. The direct conversion receiver of claim 20, wherein the feedback signal generating circuit comprises:
a first route through which a drain current of the first transistor added to a drain current of the fourth transistor flows;
a second route through which the feedback current flows, and configured to generate the feedback signal according to the feedback current; and
a bias voltage generating circuit configured to provide bias voltages to the first route and the second route respectively.

23. The direct conversion receiver of claim 20, wherein the calibrating circuit provides an output current pair based on the feedback signal.

24. The direct conversion receiver of claim 20, further comprising a tuning circuit configured to adjust a mismatch of the mixer.

25. The direct conversion receiver of claim 24, wherein the tuning circuit generates a calibrating current according to a calibration code, and the calibrating circuit provides the mixer output terminal pair with an output current pair based on the feedback signal and the calibrating current.

26. The direct conversion receiver of claim 25, further comprising a code generator for generating the calibration code according to a mismatch of the mixer.
